(19) United States
(12) Patent Application Publication
(10) Pub. No.: US 2018/0236398 A1
(43) Pub. Date: Aug. 23, 2018

(54) AIR DRYER CARTRIDGE, AIR DRYER AND COMMERCIAL VEHICLE COMPRISING AN AIR DRYER CARTRIDGE

(71) Applicant: Haldex Brake Products Aktiebolag, Landskrona (SE)

(72) Inventor: Siegfried Heer, Wiesloch (DE)

(21) Appl. No.: 15/962,054

(22) Filed: Apr. 25, 2018

Related U.S. Application Data
(63) Continuation of application No. PCT/EP2016/078625, filed on Nov. 24, 2016.

(30) Foreign Application Priority Data
Dec. 4, 2015 (EP) 15 198 068.7

(51) Int. Cl. B01D 53/26; B01D 53/04; B01D 46/00

(52) U.S. Cl. CPC B01D 53/261; B01D 53/0415; B01D 46/0031; B01D 2259/40083; B01D 2259/40003; B01D 2259/40007; B01D 46/0087

(57) ABSTRACT

The invention relates to an air dryer cartridge (5) for a compressed air system of a commercial vehicle.

According to the invention, the air dryer cartridge (5) comprises a base element coupling region (6) by which the air dryer cartridge (5) can be coupled to a base element (4) of an air dryer (1). Furthermore, the base element coupling region (6) of the air dryer cartridge (5) comprises a control port (93) for a control signal for a release valve (40). Furthermore, a release valve coupling region (94) is provided at the air dryer cartridge (5), a release valve (40) being coupled or coupleable to the release valve coupling region (94).

According to the invention, the base element coupling region (6) and the release valve coupling region (94) are arranged on opposite sides of the air dryer cartridge (5). Preferably, the inventive air dryer cartridge (5) can be assembled from below to a base element (4). The control signal for controlling the release valve (40) can be passed by a control line of control conduit (44) through the interior of the air dryer cartridge (5), in particular through a desiccant (14).

### CROSS REFERENCE TO RELATED APPLICATIONS

This application is a continuation of International Application PCT/EP2016/078625 with an international filing date of Nov. 24, 2016 and claiming priority to European Patent Application No. EP 15 198 068.7 entitled “Lufttrocknungskartusche, Lufttrockner and Nutzfahrzeug mit einer Lufttrocknungskartusche”, filed on Dec. 4, 2015.

### FIELD OF THE INVENTION

The present invention relates to an air dryer cartridge. The air dryer cartridge is used in a compressed air system of a commercial vehicle for the purpose of processing compressed air, in particular by removing humidity, by removing other fluids as fine oil droplets stemming from a compressor and/or by removing contaminants, e.g. embodied as particles or foreign bodies carried along by the compressed air. Furthermore, the invention relates to an air dryer wherein an air dryer cartridge is provided. Finally, the invention relates to a commercial vehicle which is equipped with an air dryer cartridge or an air dryer.

### BACKGROUND OF THE INVENTION

Common air dryer cartridges are mounted onto a base element which is connected to a vehicle frame of a commercial vehicle. In the air dryer cartridge the compressed air is fed through filters, labyrinth-type collectors or traps, cyclones and at least one desiccant as in particular silica gel in order to remove humidity, fluids or contaminants from the compressed air. The compressed air can be supplied and discharged via an inlet and an outlet of the base element. For a sealed connection of the air dryer cartridge to the base element, then the compressed air flows from the inlet of the base element through the air dryer cartridge via the outlet of the base element to other components of the compressed air system and consumers of the same.

In the air dryer cartridge suitable accommodating spaces for collected humidity, fluids and contaminants have to be provided. Dependent on the filling of the accommodating spaces and the extent of the contamination of the filter and/or of the desiccant and dependent on the capability of a regeneration of the desiccant, a regular or irregular replacement of the air dryer cartridge is required. An interval of the exchange of the air dryer cartridge can in some cases be extended if an accommodating space for humidity, a fluid or contaminants is provided in the region of the base element or the connecting region between the air dryer cartridge and the base element and if a release valve is associated with the accommodating space. If the release valve is controlled into an open position, the release valve connects the accommodating space to the environment. Accordingly, compressed air is transferred from the compressed air system through the accommodating space, here humidity, the fluid or contaminants being taken along, to the environment.

DE 32 16 329 A1 discloses an air dryer having a housing comprising multiple parts. In the housing the compressed air fed by a compressor is guided from an inlet in vertical and downward direction along a meandering path against deflector surfaces for collecting humidity. In the bottom region of the housing of the air dryer, an outlet valve is arranged. By the outlet valve, collected humidity can be transferred to the environment. A reservoir comprising a desiccant is inserted into the upper, base-like housing part of the air dryer. The reservoir comprises a hollow, ring-shaped reservoir housing being open in upper direction. In a semi cross section the reservoir housing is U-shaped. A compression spring which is supported at the base-like housing part of the air dryer presses a circular ring-shaped reservoir lid towards to bottom of the reservoir housing. In this way a desiccant is compressed between the reservoir lid and the bottom of the reservoir housing. Both the bottom of the reservoir housing as well as the reservoir lid comprise recesses such that the compressed air is able to flow from the bottom in upper direction through the reservoir housing and the desiccant. A rod extends through the inner bore of the reservoir housing. A longitudinal bore of the rod serves as a control conduit for transmitting a control pressure to a control chamber which is arranged in the lower end region of the rod. In the control chamber, a sealed control piston is arranged. By the control piston it is possible to actuate the outlet valve. With the switching from an load phase of the air dryer into an idle phase, a pressure controller pressurizes the control conduit in the rod and so pressurizes the control chamber so that the tappet opens the outlet valve. Accordingly, both humidity collected in the bottom region of the reservoir as well as humidity of the desiccant are transferred to the environment. The humidity of the desiccant is transferred to the environment for the purpose of a regeneration of the desiccant.

Further prior art is known from the publications DE 19 47 550 A1 (corresponding to U.S. Pat. No. 3,592,563A1), U.S. Pat. No. 3,472,000 A and EP 0 036 569 A1.

### SUMMARY OF THE INVENTION

The invention bases on the object to propose an air dryer cartridge which is improved with respect to
the design options and the options for the orientation and arrangement of the air dryer cartridge, the base element and/or the release valve,
the control options of the release valve,
the integration of the air dryer cartridge and the air dryer into a commercial vehicle,
the assembly and disassembly or exchange of an air dryer cartridge.

Furthermore, the invention bases on the object to propose a correspondingly improved air dryer. Another object of the invention relates to the improvement of a commercial vehicle comprising an air dryer cartridge or an air dryer.

The invention relates to an air dryer cartridge for a compressed air system of a commercial vehicle. According to the invention, the air dryer cartridge comprises a base element coupling region. By the base element coupling region it is possible to couple the air dryer cartridge to a base element of an air dryer. This coupling can serve for supporting the air dryer cartridge at the base element and/or for establishing the pneumatical and/or electrical connections. It is possible that also sealing elements as sealing rings are clamped in the region of the base element coupling region between the base element and the air dryer cartridge and/or further elements as filters, housing parts or other components are clamped or trapped. Preferably, the base element coupling region is the front side of the air dryer cartridge facing towards the base element which is preferably not planar and comprises a plurality of different components of the air dryer cartridge.

Within the frame of the invention, the base element coupling region in some cases comprises an inlet and/or an outlet for the compressed air flowing through the air dryer cartridge. In any case, the air dryer cartridge comprises a control port in the base element coupling region which serves for the transmission of the control signal for controlling a release valve by which a controlled removal of humidities, fluids or contaminants is provided. Preferably, the inlet, the outlet and the control port are arranged in the base element coupling region.

Furthermore, within the frame of the invention the air dryer cartridge comprises a release valve coupling region to which the release valve can be coupled or is coupled.

According to the invention, the base element coupling region and the release valve coupling region are arranged on opposite sides of the air dryer cartridge. By this measure the design options are extended over the options according to the prior art for which generally the base element coupling region and the release valve coupling region are arranged on the same side of the air dryer cartridge. According to the invention, it is in particular no longer required that the release valve is necessarily arranged in the region of the base element or on the side of the air dryer cartridge facing towards the base element. Instead, the release valve can be shifted to the other side of the air dryer cartridge. Accordingly, constructional space requirements in the base element coupling region and in the connecting region between the base element and the air dryer cartridge can be simplified because it is no longer required to arrange the release valve in this region.

In the case that the air dryer cartridge explained above is used in a “classical design” with an assembly onto a base element, this means that the release valve is arranged on the upper side of the air dryer cartridge. In this case, the “blowing out” of humidity, fluids or contaminants can also be directed in upper direction or the removal of the humidity, fluids or contaminants is provided from the release valve in downward direction. However, it is also possible that the air dryer cartridge is used in a “lying” orientation so that the air dryer cartridge extends from a base element with its longitudinal axis in horizontal direction (e.g. in longitudinal direction of the vehicle or in transverse direction of the vehicle). However, it is also possible that the air dryer cartridge extends from the base element in a new, reversed design in downward direction. In this case, the release valve can be arranged below the base element (and below the filter and the desiccant of the air dryer cartridge). Accordingly, in some cases it can be provided that the humidity, fluids or contaminants are fed by gravitational forces in downward direction to the release valve. It is possible that the opening of the release valve directly leads to the discharge of the humidity, fluids or contaminants in downward direction into the environment.

Preferably, the at least one desiccant and/or at least a filter are/is arranged between the base element coupling region and the release valve coupling region.

For the control of the release valve (which also covers a closed-loop control) the feeding of a control signal to the release valve is required. Here, it is possible that the release valve or the air dryer cartridge comprises a port which is located remote from the base element or in the release valve coupling region. Via the port then the control signal can be supplied. If the control signal is a pneumatic control signal which is controlled electro-magnetically at another place, the control signal can be fed to the air dryer cartridge or to the release valve or to the release valve coupling region via an external conduit as a plastic conduit which is in some cases a flexible conduit. A disassembly of the air dryer cartridge from the base element for a replacement against a new air dryer cartridge however then requires that additionally to the disassembly of the air dryer cartridge from the base element it is required to release the connection of the conduit to the port for the control signal. Then after the assembly of the new air dryer cartridge the connection has to be re-established which leads to an increased effort for assembly and disassembly. Instead, for another embodiment of the invention it is proposed that a control conduit or control line by which a control signal for controlling the release valve is transmitted extends from the base element coupling region (at least partially) through the interior of the air dryer cartridge to the release valve coupling region. In this way it can be provided that the external line or conduit by which the control signal (which is controlled at another place) is fed to the air dryer cartridge is to be connected to the base element. For a disassembly of the air dryer cartridge then a release of the connection of the external line or conduit to the base element is no longer required. In this case, the control signal is fed from the mentioned external control line or control conduit via the inlet port of the base element and the base element coupling region to the control line or control conduit which extends through the interior of the air dryer cartridge. In this way, it is then possible to transmit the control signal to the release valve coupling region from where then the control signal approaches the release valve.

With the frame of the invention, the control line or control conduit might extend at any location with any orientation and any line routing or arrangement of the conduits through the interior of the air dryer cartridge. It is e.g. possible that the control line or control conduit extends through an intermediate space between an inner housing and an outer housing of the air dryer cartridge, through a conduit of the outer housing of the air dryer cartridge or through a chamber of the air dryer cartridge. For another proposal of the invention, the control line or control conduit extends through a desiccant of the air dryer cartridge.

The control line or control conduit might be formed by any component of the air dryer cartridge which might only serve for this function or might also fulfil other functions. For another embodiment of the air dryer cartridge, it is proposed that a transmitting body is provided which might be e.g. formed as an elongated body, a tube and the like. The transmitting body forms the control line or control conduit and extends through the interior of the air dryer cartridge or through the desiccant.

The transmitting body might serve for any other function besides the formation of the control line or control conduit. For one proposal of the invention, the transmitting body is formed integrally or as one piece with an accommodating body for the desiccant, with a connecting region for connecting the control line or control conduit of the transmitting body electrically and/or pneumatically in a sealed fashion to a connecting region of the base element and/or with a connecting region for connecting the control line or control conduit of the transmitting body electrically and/or pneumatically in a sealed fashion to the release valve. In this way, the construction effort can be reduced.

For a particular proposal of the invention, the control line or control conduit (or the transmitting body) extends in the region of the longitudinal or rotational axis of the air dryer cartridge or coaxially to the same. In this way, a symmetry of the air dryer cartridge is not affected in the region of the control line, control conduit or transmitting body. An arrangement of the control line or control conduit coaxial to the longitudinal or rotational axis of the air dryer cartridge might be of particular importance if the air dryer cartridge is assembled with the base element by a rotating movement of the air dryer cartridge as e.g. being the case for a so-called spin-on-cartridge. For spin-on-cartridges of this type, by the arrangement of the control line or control conduit coaxially to the longitudinal or rotational axis of the air dryer cartridge it is possible to keep the path of the connecting region of the air dryer cartridge for connecting the control line or control conduit of the transmitting body relative electrically and/or pneumatically in a sealed fashion to the associated connecting region of the base element during the rotating movement small. Accordingly, a friction path that has to be passed is reduced and the biasing of sealing elements arranged in the connecting regions can be reduced.

For one proposal according to the invention the control conduit is a pneumatic control conduit for a pneumatic control pressure. Here, the pneumatic control pressure can e.g. be generated by a solenoid valve arranged in the region of the base element or at another position of the air dryer or also outside from the air dryer, e.g. in an air processing device comprising multi circuit protection valves.

For another proposal of the invention, the control line is an electric control line for an electric control signal. In this case, the electric control signal can be used for electro-magnetically or electro-pneumatically switching the release valve.

It is possible that also a heating element is provided in the region of the release valve in order to avoid a freezing of the humidity or the fluid (in some cases with contaminants contained therein) in the region of the release valve and in order to guarantee the proper operation of the release valve. In this case, a heating line or heating conduit by which a heating signal for controlling the heating element is transferred in the region of the release valve might extend from the base element coupling region (at least partially) through the interior of the air dryer cartridge to the release valve coupling region. Here, generally for the heating line or heating conduit the same applies as previously said concerning the control line or control conduit for controlling the release valve: The heating line or heating conduit might e.g. be provided by or at the transmitting body, might extend through a desiccant of the air dryer cartridge and might extend in the region of or coaxially to the longitudinal or rotational axis of the air dryer cartridge. The heating signal in the heating line or heating conduit might be an electric power supply of the heating element or a heated heating fluid which is transmitted by the heating line or heating conduit to the heating element.

The air dryer cartridge might generally have a design according to the design of a plurality of different air dryer cartridges known from the prior art. In a preferred embodiment, the air dryer cartridge is a so-called spin-on-cartridge. A spin-on-cartridge of this type comprises an inner thread in the base element coupling region. In the region of the inner thread the cartridge is screwed onto an outer thread of the base element. Here, the inlet or the outlet for compressed air flowing through the air dryer cartridge might be formed inside of the aforementioned threads. For an alternative or cumulative embodiment, it is possible that inside of these threads the control port for the control signal for controlling the release valve is arranged. With continued screwing the base element coupling region is pressed against the base element. In this way, electrical connections can be established and/or pneumatically sealed connections between the air dryer cartridge and the base element can be established.

For an alternative embodiment it is possible that the air dryer cartridge is an insertion cartridge. In this case, an inner space is limited in the air dryer by the base element and a housing lid of the air dryer. In this inner space then the insertion cartridge can be arranged. The insertion cartridge can be trapped in the inner space between the base element and the housing lid (e.g. also pre-tensioned by a spring).

Another solution of the object of the invention is an air dryer which comprises a base element as well as an air dryer cartridge as explained above, the air dryer cartridge being held at the base element.

For another embodiment of the invention, in the air dryer an electric or pneumatically sealed connection between the base element and the base element coupling region of the air dryer cartridge is automatically established during the assembly of the air dryer cartridge with the base element. Accordingly, additional to the mentioned assembly no additional assembly steps are required for establishing the connection(s). After the assembly then the reliable transmission of the control signal from the base element to the control line or control conduit of the air dryer cartridge is guaranteed.

Preferably, the air dryer comprises a housing lid which then together with the base element limits the interior space. In the interior space the air dryer cartridge (here embodied as an insertion cartridge) can be arranged. For this embodiment, the housing lid is connected by a bayonet connection to the base element or can be connected by a bayonet connection to the base element. However, also other connections between the housing lid and the base element can be used within the frame of the invention.

For another inventive air dryer, a solenoid valve which serves for generating a control pressure for the release valve can be integrated into the base element. The control pressure generated in this way is then transferred by the control conduit through the air dryer cartridge to the release valve.

For an alternative or cumulative embodiment it is possible that a solenoid valve is integrated into the base element. The solenoid valve serves for controlling a regeneration. For this purpose, a non-return valve normally blocking a reverse flow can be integrated into the base element (e.g. into the inlet). The aforementioned solenoid valve can be integrated into a bypass conduit bypassing the non-return valve. This solenoid valve then in an open state provides the regeneration.

It is generally possible that the release valve or components of the same or the heating element forms a fixed component of the air dryer cartridge. However, this design leads to the consequence that for an exchange of the air dryer cartridge the new air dryer cartridge also has to be equipped with a release valve or a heating element so that the costs and the constructional effort for the air dryer cartridge are increased. According to another proposal of the invention, the release valve or a valve seat, a valve body, a valve piston and/or a valve spring of the release valve is/are releasably connected to the housing lid and/or the air dryer cartridge. It is also possible that the heating element is releasably connected to the housing lid and/or the air dryer cartridge. Accordingly, for an exchange of a housing lid or the air dryer cartridge at first the release valve or the valve elements of the same and/or the heating element is/are disassembled. Then the air dryer cartridge is replaced and another assembly of the same components of the release valve or the heating element takes place. Accordingly, independent on the replacement of the air dryer cartridge the same release valve or the same heating element can be used.

Another solution of the object of the invention is given by a commercial vehicle which is equipped with an air dryer cartridge or an air dryer as described above. For the inventive solution the air dryer cartridge is mounted (in particular with the longitudinal axis oriented in vertical direction) or laterally (in particular with a longitudinal axis having an orientation in horizontal direction) to the base element.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIGS. 1 to 6 in a longitudinal section show embodiments of an air dryer comprising an air dryer cartridge.

### DETAILED DESCRIPTION

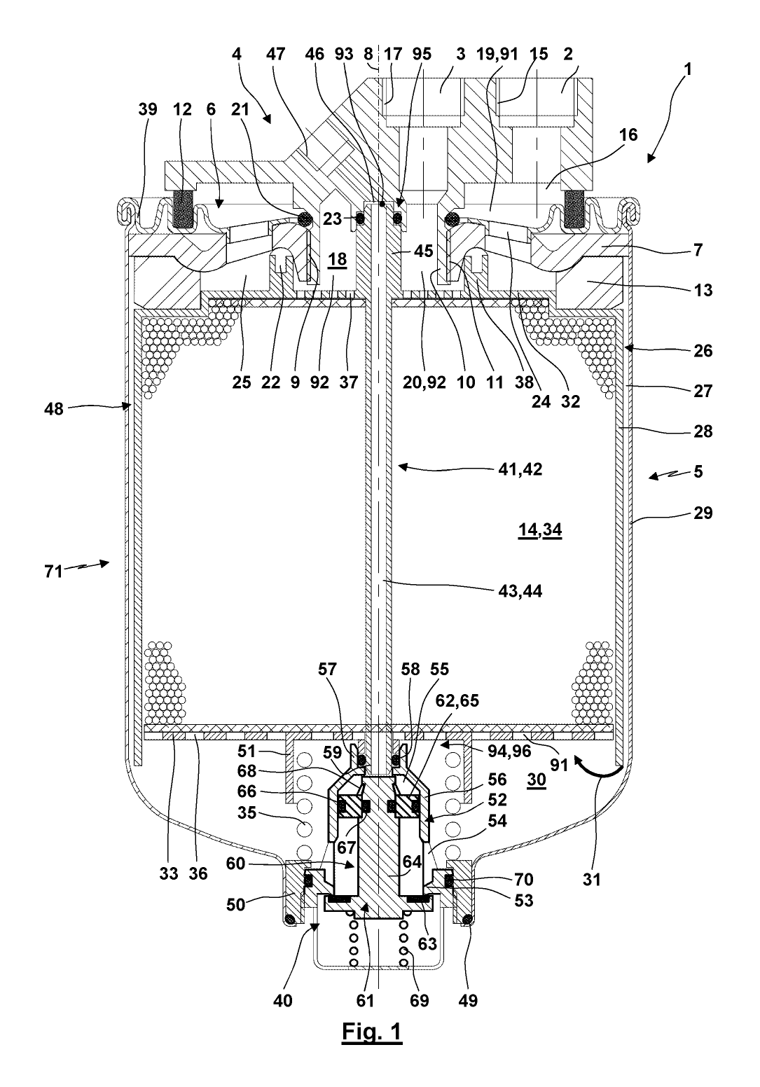

FIG. 1 shows an air dryer 1. The air dryer 1 is a part of a compressed air system of a commercial vehicle. In the compressed air system an inlet 2 of the air dryer 1 is connected to a compressed air source (in particular a compressor). An outlet 3 of the air dryer 1 is connected to consumers of the commercial vehicle (e.g. a first and second service brake circuit, an air suspension circuit, an auxiliary consumer circuit and/or a trailer brake circuit). In particular a multi circuit protection valve is interposed between the outlet 3 and the aforementioned consumer circuits. With respect to the general design of the compressed air system wherein the air dryer 1 is used, reference is made to the plurality of the related prior art embodiments.

According to FIG. 1, the air dryer 1 comprises an air dryer cartridge 5 and a base element 4 which is here formed by one single part and e.g. embodied as cast part or cast plate. In the assembly situation shown in FIG. 1 the air dryer cartridge 5 is mounted from below to the base element 4 such that a longitudinal axis 8 has an orientation in vertical direction. The air dryer cartridge 5 cooperates or engages with the base element 4 in the region of a base element coupling region 6 which is formed by the upper front face of the air dryer cartridge 5. This engagement or cooperation enables a mounting of the air dryer cartridge 5 to the base element 4 and serves for providing the sealed and in each case separate transfer of compressed air which might be a controlling compressed air flow and/or the flow of the compressed air to be dried between the air dryer cartridge 5 and the base element 4. The base element is fixedly mounted to the commercial vehicle (e.g. to a vehicle frame of the same or other components supported thereat).

According to FIG. 1, the air dryer cartridge 5 is a so-called “spin-on-cartridge”. For this purpose, the air dryer cartridge 5 comprises a base body 7 which is here arranged on top and which comprises a bore with an inner thread 9 having an orientation coaxial to the longitudinal or rotational axis 8 of the air dryer cartridge 5. The base element 4 comprises a here sleeve-like protrusion 10 which comprises an outer thread 11 that corresponds to the inner thread 9. Accordingly, it is possible to screw the inner thread 9 of the air dryer cartridge 5 from below to the outer thread 11 of the base element 4. For this purpose, the air dryer cartridge 5 is rotated about the longitudinal or rotational axis 8. With the continued screwing the base element coupling region 6 of the air dryer cartridge 5 comes closer and closer to the adjacent front face of the base element 4. With this movement a ring-shaped sealing element 12 (which is on the lateral outer side held in the region of the base element coupling region 6 of the air dryer cartridge 5 at the base element coupling region 6) is clamped between the front side of the base element 4 and the base element coupling region 6. Accordingly, in the assembled state the air dryer 1 is sealed in outer direction in the region of the interface between the base element 4 and the air dryer cartridge 5.

For cleaning of the compressed air the compressed air flows from the inlet 2 on its way to the outlet 3 through a filter element 13 and a desiccant 14. As being known from the prior art, dependent on the needs the design of the at least one desiccant 14 and/or the at least one filter element 13 might vary. Also any sequence of the at least one filter element 13 and the at least one desiccant 14 is possible.

For the embodiment according to FIG. 1, the flow of the compressed air through the air dryer 1 is provided as follows:

In the region of the inlet 2 of the base element 4 an inlet port 15 is provided. The inlet port 15 is permanently pneumatically connected to a base element inlet chamber 16 arranged on the lower front face of the base element 4 facing towards the base element coupling region 6 of the air dryer cartridge 5. In a corresponding way an outlet port 17 formed in the region of the outlet 3 of the base element 4 is permanently pneumatically connected to a base element outlet chamber 18. The base element outlet chamber 18 is also arranged on the underside of the base element 4 on the front side of the base element 4 facing towards the base element coupling region 6 of the air dryer cartridge 5. For the shown embodiment the base element outlet chamber 18 is formed within the inner bore of the sleeve-like protrusion 10.

In the base element coupling region 6 the air dryer cartridge 5 forms an inlet 91 (here embodied as an air dryer cartridge inlet chamber 19) and an outlet 92 (here embodied as an air dryer cartridge outlet chamber 20). In the assembled state, in a sealed fashion the compressed air is transferred from the base element inlet chamber 16 to the air dryer cartridge inlet chamber 19. In a corresponding way, compressed air is transferred from the air dryer cartridge outlet chamber 20 to the base element outlet chamber 18. The air dryer cartridge inlet chamber 19 is a ring chamber which is sealed on the radial outer side against the environment by the sealing element 12 and sealed on the radial inner side by another ring-shaped sealing element 21 which is clamped in the region of the base element coupling region 6 between the air dryer cartridge 5 and the base element 4. Also the air dryer cartridge outlet chamber 20 is a ring chamber being sealed on the radial outer side by sealing elements 21, 22 and on the radial inner side by another ring-shaped sealing element 23 which will be explained in the following. By the ring-shaped design of the chambers 19, 20 it is possible to provide the sealed transition of the compressed air independent on the screwing angle by which the air dryer cartridge 5 is rotated during the screwing to the base element 4 about the longitudinal or rotational axis 8.

The compressed air which is to be cleaned flows from the air dryer cartridge inlet chamber 19 which forms the inlet 91 of the air dryer cartridge 5 through a plurality of bores 24 of the base body 7. The bores 24 are dispersed along the circumference and have an orientation parallel to the longitudinal or rotational axis 8. A flow conduit 25 is formed between the lower side of the base body 7 and the upper side of a top plate 32 of an accommodating body 26 for the desiccant 14. Via the flow conduit 25 the compressed air approaches the filter element 13 with a component of the flow having an orientation in radial outer direction. The filter element 13 is clamped between the lower side of the base body 7 and the upper side of the top plate 32 of the accommodating body 26. After the flowing through the filter element 13, the compressed air arrives in a hollow cylindrical intermediate space 27 which is formed between a hollow cylindrical wall 28 of the accommodating body 26 and a hollow cylindrical outer housing 29 of the air dryer cartridge 5. The compressed air flows through the intermediate space 27 in vertical downward direction into a lower chamber 30 of the air dryer cartridge 5 wherein the compressed air is subjected to a deflection 31.

In the shown longitudinal section the accommodating body 26 for the desiccant 14 comprises (in a rough approximation) the shape of an inverted U. The base leg of the U is formed by the top plate 32. The side legs of the U are formed by the wall 28. A bottom plate 33 is displaceably inserted into the opening of the U respectively the accommodating body 26 opening to the downside. The bottom plate 33 and the accommodating body 26 limit a cylindrical inner space 34 wherein the desiccant 14 is trapped. The bottom plate 33 is here biased by a compression spring 35 being effective in a direction coaxial to the longitudinal or rotational axis 8. Accordingly, a certain compression of the desiccant 14 in the accommodating body 26 is achieved.

After the deflection 31 the compressed air flows through bores 36 of the bottom plate 33, the inner space 34 with the desiccant 14 and bores 37 of the top plate 32 and finally arrives at the air dryer cartridge outlet chamber 20 forming the outlet 92 of the air dryer cartridge 5 with the subsequent transition to the outlet port 17 of the base element 4. The top plate 32 carries (here as one piece) a ring-shaped protrusion 38. The sealing element 22 is held at the protrusion 38. For the shown embodiment, the base body 7 is covered by a top metal sheet 39 in the base element coupling region 6. The top metal sheet 39 is deformed or folded for accommodating the sealing element 12 and is deformed or beaded in the outer edge region for a connection to the wall 28 of the accommodating body 26 (which is here also formed by a metal sheet).

The sealing element 12, the air dryer cartridge inlet chamber 19, the sealing element 21, the inner thread 9 and the base element outlet chamber 18 are arranged in the base element coupling region 6 of the air dryer cartridge 5 (which is formed by the front side of the air dryer cartridge 5 facing towards the base element and which is arranged on the top in the assembled state).

For the inventive embodiment, in a release valve coupling region the air dryer cartridge 5 comprises a release valve 40 which is located in the region of the lower chamber 30. For a removal of humidity, fluids or contaminants from the interior of the air dryer cartridge, the release valve 40 connects the lower chamber 30 to the environment. The release valve 40 is a 2/2-way valve. Due to the bias by a valve spring 69 without any control action, the release valve takes its closed position. With a pneumatic control action the release valve takes its open position. If the release valve 40 is opened, the compressed air carries along contaminants, humidity and fluids from the desiccant 14, the filter element 13 and other components, conduits or channels and chambers and in particular fluids, humidity and contaminants collected in particular in the region of the lower chamber 30 and transfers these into the environment. The pneumatic control signal for controlling the release valve 40 is transmitted from the base element coupling region 6 to the release valve 40 via a transmitting body 41 through the inner space 34 and through the desiccant 14. For the embodiment according to FIG. 1, the transmitting body 41 is a tube 42 with an inner bore 43. The inner bore 43 forms a control conduit 44 for a control pressure.

In the upper end region, the control conduit 44 of the transmitting body 41 opens into a sleeve-like protrusion 45. The sleeve-like protrusion 45 is a part of the base element coupling region 6 and forms a connecting region 95. By the connecting region 95 the control conduit 44 of the air dryer cartridge 5 is connected to a control inlet or control input 93 (in the following also control port) of the base element 4. The connecting region 95 of the protrusion 45 enters sealed by the sealing element 23 into a recess 46 of the base element 4. The recess 46 is pneumatically connected to the control inlet or control input 93 which comprises a control port 47. Accordingly, it is possible to transmit a control pressure generated at the control port 47 via the transmitting body 41 and the control conduit 44 of the same through the interior of the air dryer cartridge 5 to the other side to the release valve 40. Without this necessarily being the case, for the shown embodiment the transmitting body 41 forms a single piece with the accommodating body 26. The insertion body 48 formed in this way might e.g. be a deep-drawn part or injection molding part.

The release valve 40 is arranged on the side facing away from the base element 4 in the release valve coupling region 94 of the air dryer cartridge 5. The dome-shaped outer housing 29 is rigidly connected with the sealing by a sealing element 49 to a ring flange 50 which defines an opening. The compression spring 35 is clamped under a pretension between the inner ring-shaped front surface of the ring flange 50 and the bottom plate 33. For the guidance of the compression spring 35 the bottom plate 33 (here integrally) comprises a guiding sleeve 51 protruding in downward direction into the lower chamber 30. An insertion body 52 is (under the sealing by a sealing element 70) screwed into an inner thread of the ring flange 50. The insertion body 52 generally has the shape of a stepped sleeve.
A step is formed in the lower end region a valve seat 53,
through recesses 54 provide a transit of compressed air with humidity, fluids and contaminants into the interior of the insertion body 52 and (for opened release valve 40) from there into the environment,
the insertion body 52 forms a cylinder region 56 limiting a pressure chamber 55 and
the insertion body 52 is connected in the upper end region with a connecting region 57 under the sealing by a sealing element 58 to an end region 59 of the transmitting body 41 which protrudes in downside direction from the bottom plate 33, the transmitting body 41 forming a connecting region 96 of the air dryer cartridge 5 for its connection to the release valve 40.

For the shown embodiment, the valve body 60 of the release valve 40 comprises two valve body parts 61, 62 which are here fixedly connected to each other. The valve body part 61 forms both a valve disc 63 as well as a valve tappet 64 which are formed as one piece in the shape of inverted T. The valve disc 63 here forms the horizontal leg of the T. The valve tappet 64 forms the vertical leg of the T which has an orientation coaxial to the longitudinal axis 8. In the end region facing away from the valve disc 63 the valve tappet 64 carries the valve body part 62 which is a ring piston 65. Under a sealing by a sealing element 66 the ring piston 65 is guided for being displaced relative to the inner surface of the cylinder region 56. On the radial inner side the ring piston 65 is sealed by a sealing element 67 against the valve tappet 64. For the shown embodiment, the ring piston 65 is slid from the top upon the valve tappet 64 against a shoulder of the valve tappet 64. In this axial position achieved by the sliding movement the ring piston 65 is secured by a latching element 68. The pressure chamber 55 by which the ring piston 65 is biased is pneumatically connected to the control conduit 44 by an intermediate space between the adjacent front sides on the one hand of the valve tappet 64 and on the other hand of the transmitting body 41 or radial bores of the end region 59 of the transmitting body 41. Without pressure being applied to the control port 47 and to the control conduit 43 as well as to the pressure chamber 55, by the valve spring 69 the valve body 60 is pressed together with the valve disc 63 against the valve seat 53 so that the release valve 40 is closed. Instead, the pressurization of the control port 47, of the control conduit 43 and of the pressure chamber 55 leads to an opening force biasing the ring piston 65 and moving the valve body 60 from the operating position shown in FIG. 1 against the bias by the spring 69 in opening direction. In this way, a transition cross section to the environment is established between the valve seat 53 and the valve disc 63.

For the embodiment according to FIG. 1, the air dryer cartridge 5 is a merchantable constructional unit wherein the outer housing 29 is closed against the environment by the release valve 40 and the top metal sheet 39 and the base body 7 except the control port 93, the inlet 91 and the outlet 92 respectively the chambers 19, 20 being arranged in the base element coupling region 6.

For this embodiment it is possible that the air dryer cartridge 5 is supplied without the components of the release valve 40. For a replacement of the air dryer cartridge 5 the release valve 40 is disassembled from the old air dryer cartridge and then again used together with the new air dryer cartridge 5.

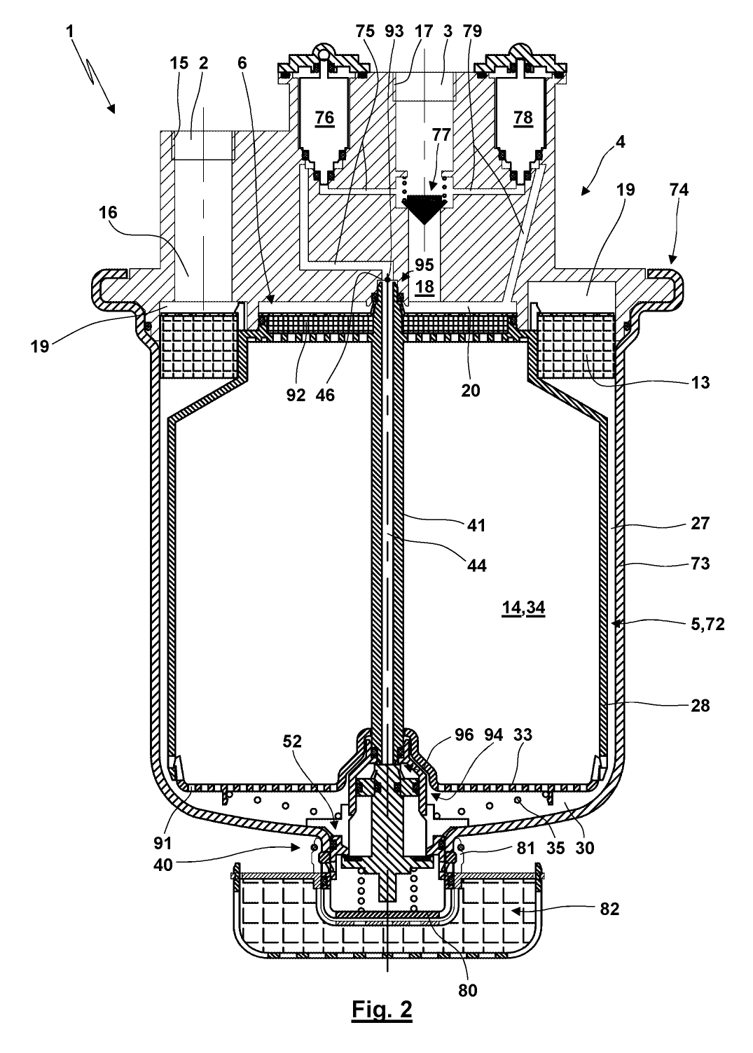

For the design of the air dryer cartridge 5 as insertion cartridge 72 the bottom plate 33 is latched as shown in the lateral edge region with the wall 28 of the accommodating body 26.

Whereas according to FIG. 1 the air dryer cartridge 5 is a spin-on-cartridge 71, FIG. 2 shows the air dryer cartridge 5 embodied as an insertion cartridge 72. The insertion cartridge 72 does not comprise as a component of the merchantable unit an outer housing 29 which seals the air dryer cartridge 5 except the pneumatical connections in the base element coupling region 6 against the environment. Here, instead of the outer housing 29 a housing lid 63 is used which can e.g. be connected to the base element 4 by a bayonet connection 74 and which together with the base element 4 delimits an inner space wherein then the insertion cartridge 72 is arranged. In this case, the filter element 13 is clamped between the insertion cartridge 72, the housing lid 73 and the base element 4. In axial direction the insertion cartridge 72 is trapped under a pretension by the compression spring 35 between the housing lid 37 and the base element 4.

Whereas according to FIG. 1 the control pressure for the release valve 40 is generated outside from the air dryer 1 and then transmitted to the control port 47, the base element 4 according to FIG. 2 does not comprise a control port 93. For this embodiment, the outlet 3 is connected via a conduit branch 75 to the recess 46 and to the control port 93 in the connecting region 95 of the air dryer cartridge 5 and so connected to the control conduit 44 in the transmitting body 41. In the conduit branch 75 a solenoid valve 76 is integrated. The solenoid valve 76 is a 3/2-way valve. The solenoid valve 76 opens the conduit branch 75 in an aerating position so that the pressure at the outlet 3 approaches the control conduit 44 as a control pressure. Instead, in the deaerating position the solenoid valve 76 closes the connection to the outlet 3 and connects the control port 93 to a deaeration. In this case the base element 4 or the solenoid valve 76 itself comprises an electrical control port by which the solenoid valve 76 is controlled by an electrical control signal from an external control unit for controlling the release valve 40.

For an alternative or cumulative embodiment, according to FIG. 2 a non-return valve 77 opening towards the outlet 3 can be arranged between the outlet of the air dryer cartridge (here the base element outlet chamber 18) and the outlet 3 of the base element. In this case, another solenoid valve 78 can be integrated into a bypass conduit 79 which forms a bypass for the non-return valve 77 and connects the outlet 92 of the air dryer cartridge (here the air dryer cartridge outlet chamber 20) respectively the base element outlet chamber 18 to the outlet 3 of the base element 4. The solenoid valve 78 is preferably a 2/2-way valve. In a closed position the solenoid valve 78 closes the bypass conduit 79. In a load phase of a compressor in the bypass conduit 79 compressed air is fed through the air dryer cartridge 5. Via the opened non-return valve 77 the compressed air approaches the outlet 3. However, a return flow for a control action of a pressure controller or for a deactivation of the compressor is blocked due to the in this state blocking non-return valve 77. If instead the solenoid valve 78 is controlled into its open position, the compressed air is able to flow in reverse direction through the air dryer cartridge 5 from the outlet 3 to the inlet 2 under a bypass of the non-return valve 77. This reverse flow can be used for a regeneration of the desiccant or (with an opening of the release valve 40 at the same time) for the removal of compressed air with humidity, fluids or contaminants into the environment.

For a particularly compact design, according to FIG. 2 in the region of the release valve coupling region 94 and in a radial inner region the bottom plate 33 has a shape being concave towards the inner space 34 so that the release valve 40 is able to partially enter into the concave shape.

According to FIG. 2 (with a function of the release valve 40 corresponding to that of FIG. 1), another design variant of the release valve 40 has been chosen: In this case the insertion body 52 is not screwed into a ring flange of the housing lid 73. Instead, in this case the insertion body 52 is latched to a hood-like lid 80. The lid 80 forms a constructional unit together with the insertion body 52 latched therewith and with the valve spring 69 and the valve body 60 being arranged in the interior. The constructional unit can be attached to the lower opening of the housing lid 73 or can be inserted therein. The securing of this constructional unit against the housing lid 73 is provided by a latching or clamping element 81 which fixedly encompasses, clasps or engages around the lower end region of the housing lid 73 as well as the lid 80. A deaeration sound absorber 82 can be mounted to the clamping element 81 or the lid 80.

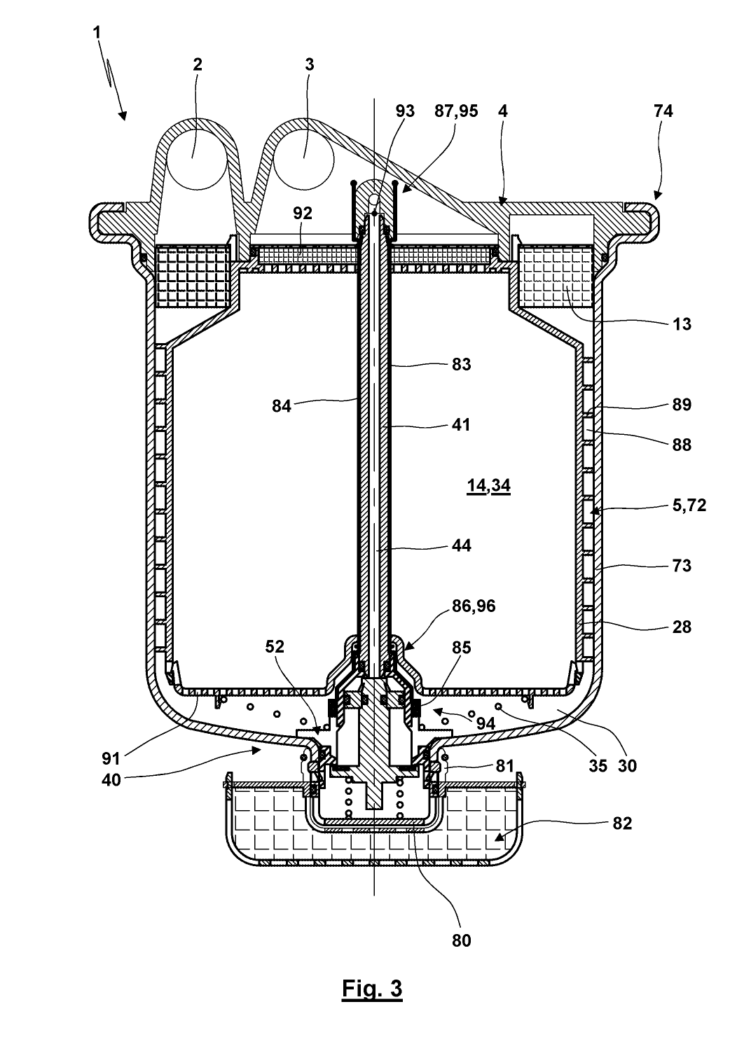

For the embodiment according to FIG. 3, the transmitting body 41 additionally to the control conduit 44 provides control lines 83, 84. The control lines 83, 84 are electric lines for an electric control signal or a controlled electric power supply. It is possible that a control line 83, 84 of this type serves for an electric control signal for the electric control of a release valve 40 having an electromagnetic design in this case. However, for the shown embodiment the control lines 83, 84 are used for transmitting an electric power supply through the air dryer cartridge 5 to a heating element 85 of the release valve 40. By the heating element 85 it is intended to avoid that the release valve 40 freezes or humidity or a fluid in the region of the lower chamber 30 freezes. For the shown embodiment, the control lines 83, 84 are provided in the region of the outer surface of the transmitting body 41. The control lines 83, 84 are insulated against a contact with the desiccant 14 and protected against mechanical damages. It is possible that the control lines 83, 84 are automatically coupled via the connecting region 96 (here electric interface 86) to corresponding control lines of the release valve 40 when assembling the release valve 40 to the transmitting body 41. In a corresponding way it is possible that with the assembly of the air dryer cartridge 5 to the base element 4 in the base element coupling region 6 of the air dryer cartridge 5 the control lines 83, 84 are directly coupled to the connecting region 95 (here an electric interface 87) to control lines of the base element 4 which are then connected to electric ports of the base element 4.

Whereas according to FIG. 2 the compressed air is able to flow from the filter element 13 in vertical and downward direction through the intermediate space 27 to the lower chamber 30, according to FIG. 3 the compressed air is guided on the way from the filter element 13 to the lower chamber 30 in the kind of a cyclone along a helical conduit 88 for achieving an improved collecting effect for fluids, humidity and/or contaminants. Here, the helically shaped conduit 88 is on the radial inner side limited by the wall 28, on the radial outer side limited by the housing lid 73 and in the direction of the longitudinal or rotational axis 8 limited by ribs 89 which extend helically around the wall 28. The ribs 89 contact with a small gap or a transition fit or pressing with its front faces the inner surface of the housing lid 73.

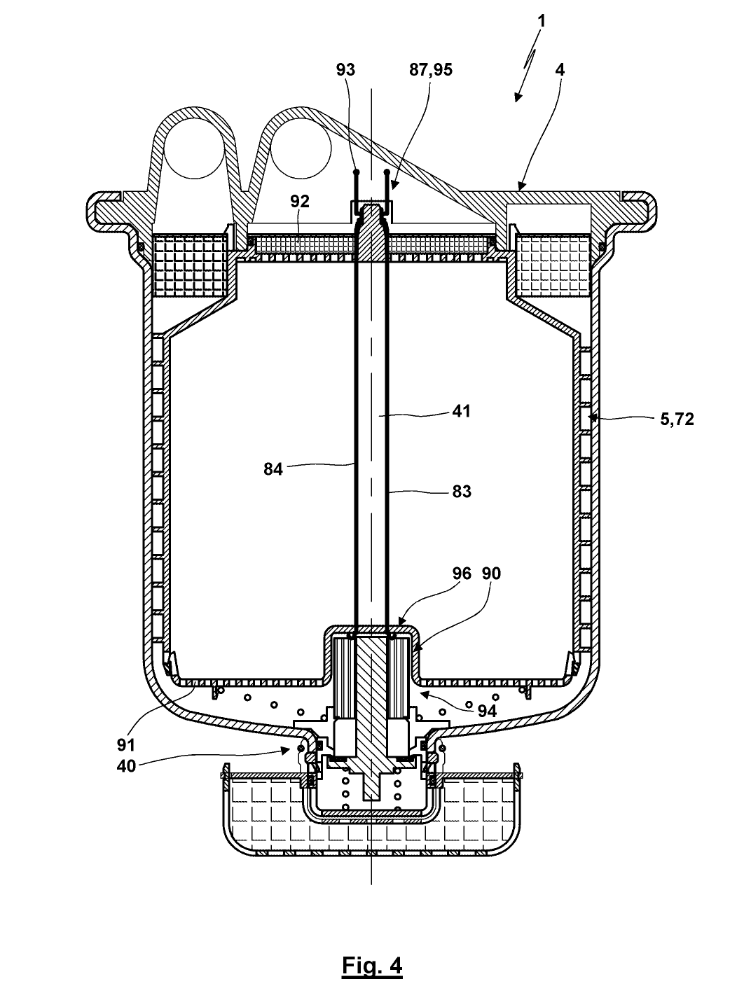

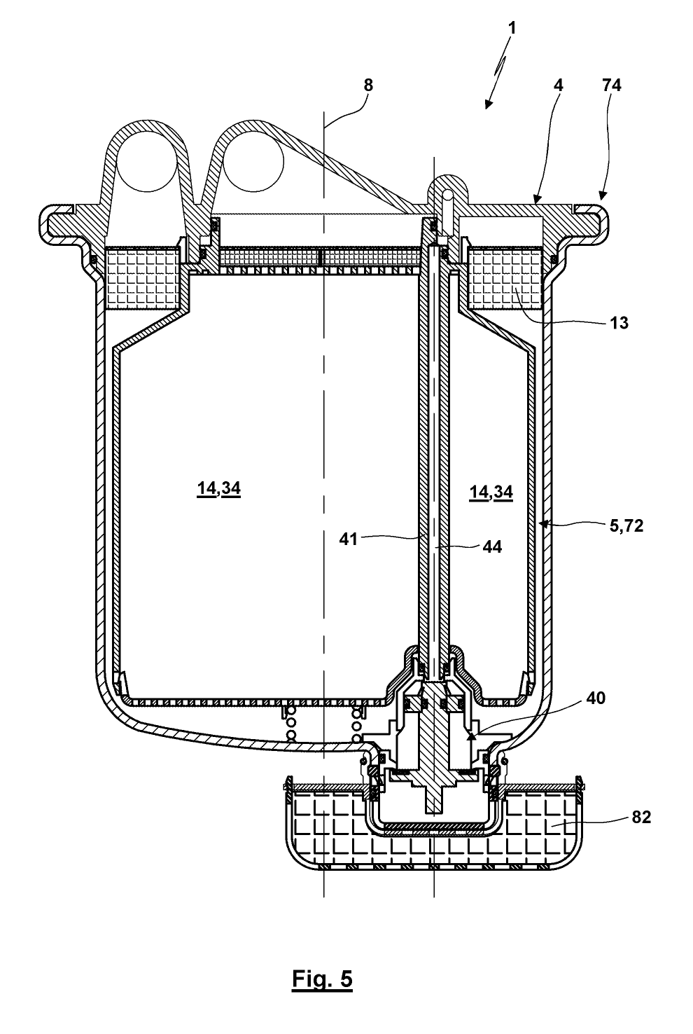

For an embodiment which in other aspects corresponds to FIG. 3, FIG. 4 shows the design of the transmitting body 41 without a control conduit 44 for the transfer of a fluidic control pressure for the release valve 40. Instead, here only the control lines 83, 84 are provided by which then an electro-mechanical actuator 90 dependent on the electrical bias of the control lines 83, 84 is able to transfer the release valve 40 into the open position and closed position.

Whereas according to the embodiments of FIGS. 1 to 4 the transmitting body 41 had an extension coaxial to the longitudinal or rotational axis 8, FIG. 5 shows an embodiment wherein the transmitting body 41 and with the transmitting body 41 the control conduit 44 does not extend centrally and coaxially to the longitudinal axis 8 through the air dryer cartridge 5. Instead, the transmitting body 41 and the control conduit 44 extend eccentrically to or distant from the longitudinal or rotational axis 8 with an orientation parallel to the same. In this case also the release valve 40 with the deaeration sound absorber 82 is arranged off-center.

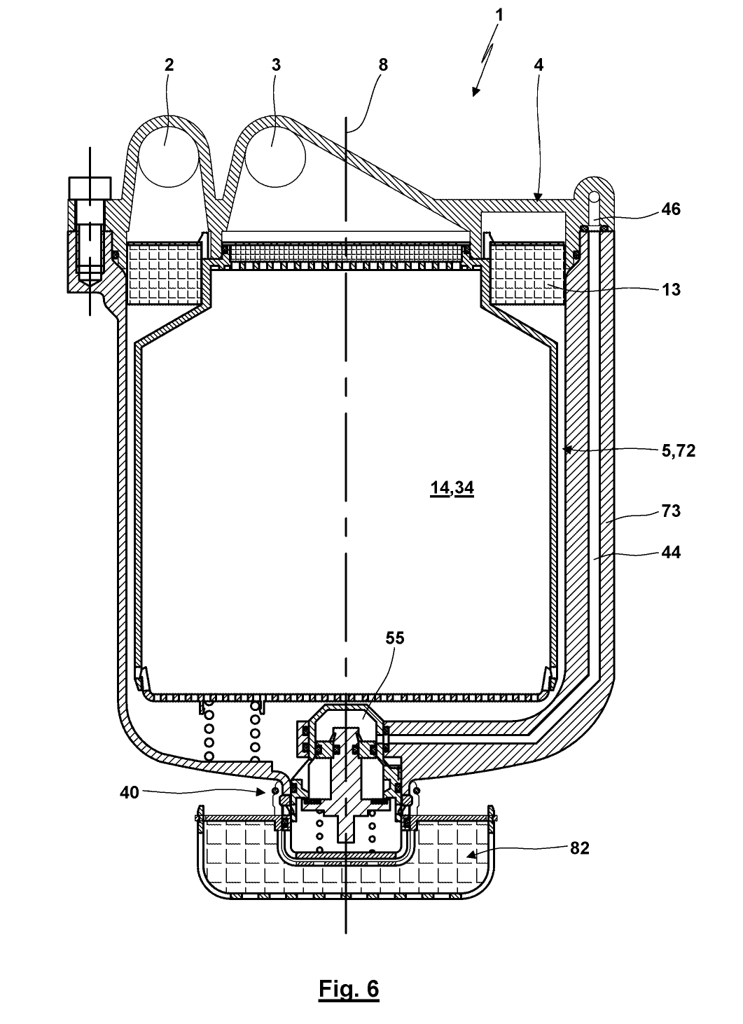

Finally, FIG. 6 shows an embodiment wherein the control conduit 44 does not extend through the desiccant 14 and within the interior of the accommodating body 26 for the same. Instead, in this case the control conduit 44 extends in the interior of the housing lid 73 and connects a recess 46 which is connected to the control port 47 to the pressure chamber 55 of the release valve 40.

In FIG. 6 instead of a bayonet connection a screwed connection is used for connecting the housing lid 73 to the base element 4.

According to FIG. 1, for the spin-on-air dryer cartridge 71 the air dryer cartridge inlet chamber 19 forms the inlet 91 for compressed air into the air dryer cartridge 5. In a corresponding way, according to FIG. 1 the air dryer cartridge outlet chamber 20 forms the outlet 92 for the compressed air for exiting from the air dryer cartridge 5. Accordingly, for this embodiment both the inlet 91 as well as the outlet 92 are arranged in the base element coupling region 6. Instead, for an insertion air dryer cartridge 72 according to FIGS. 2 to 6 the inlet 91 of the air dryer cartridge 5 is formed with the bores 36 of the bottom plate 33. The outlet 92 is in this case arranged in the exit region of the top plate 32 and in the region of the air dryer cartridge outlet chamber 20. Accordingly, here only the outlet 92 is arranged in the region of the base element coupling region 6 whereas the inlet is arranged on the opposite front side of the insertion air dryer cartridge 72.

On the side of the air dryer cartridge 5 facing away from the base element coupling region 6 (which in the assembled state is preferably arranged downstairs) the air dryer cartridge 5 comprises the release valve coupling region 94. In the region of the release valve coupling region 94 the release valve 40 is coupled to the air dryer cartridge 5. This is e.g. accomplished by fixation, latching, supporting, screwing or any other type of connection e.g. with the bottom plate 33, the outer housing 29, the ring flange 50, the housing lid 73 and the like.

The transmitting body 41 forms the upper connecting region 95 with the protrusion 45 and/or the electric interface 87. In this way at the same time also a connecting region of the air dryer cartridge 5 is formed which is a component of the base element coupling region 6.

In a corresponding way in the lower end region the transmitting body 41 forms the lower connecting region 96 by which the release valve 40 is at least pneumatically connected. The opening or outlet of the control conduit 44 of the transmitting body 41 facing towards the base element 4 forms the control port 93 of the air dryer cartridge 5.

Preferably, at least one sealing element 12, 21, 23 arranged in the base element coupling region 6 is at least partially manufactured from rubber and/or embodied as O-ring.

The base element coupling region 6 comprises e.g. (alternatively or cumulatively) the following functions and components or regions:
If the air dryer cartridge 5 is embodied as spin-on-cartridge, a base body 7 of the base element coupling region 6 comprises an inner thread 9. In the region of the inner thread 9 the base element coupling region 6 is screwed upon an outer thread 11 of the base element 4. For another design of the air dryer cartridge 5 the base element coupling region 6 comprises a mounting region for mounting the base body 7 to the base element 4.
The base element coupling region 6 comprises at least one sealing 12, 21 which is clamped in the assembled state for providing a pneumatic sealing between the base body 7 and the base element 4.
The base element coupling region 6 might partially limit a base element inlet chamber 19 formed between the base body 7 and the base element 4, a control chamber and/or a base element outlet chamber 20.
The base element coupling region 6 might comprise a recess 46, a port and/or a control port 93 by which a control signal (in particular for controlling a release valve 40) can be transferred between the base element 4 and the air dryer cartridge 5.

The release valve coupling region 94 might comprise a (ring) flange 50. In the region of the flange 50 the release valve 40 can be mounted or fixed. It is e.g. possible that a (ring) flange 50 of this type comprises an inner thread into which a component of the release valve 40 (e.g. a valve seat 53) can be screwed. Alternatively or cumulatively, it is possible that the release valve coupling region 94 comprises at least one sealing 70. The release valve coupling region 94 might also comprise a recess, a port or a control port for the release valve 40. In the case that the control signal is transmitted by the transmitting body 41, this control port can be formed by the end-sided opening of the transmitting body 41. Alternatively or cumulatively, it is possible that the release valve coupling region 94 comprises a sealing 58, a cylinder region 56 wherein a valve body part 62 (in some cases with a sealing element 66) can be housed. Accordingly, the release valve coupling region 94 serves on the one hand for the mounting and the holding of the release valve 40. On the other hand, the release valve coupling region 94 serves for the sealed and reliable transmission of a control signal for controlling the release valve 40.

The transmitting body 41 serves for transmitting a control signal via the control line or control conduit 44 from one side of the air dryer cartridge 5 (here the side facing towards the base element 4) to the other side where the release valve 40 is arranged.

The air dryer cartridge 5 is a merchantable constructional unit wherein the desiccant 14 is trapped. The desiccant 14 is elastically biased by a (bottom) plate 33 which is biased by a compression spring 35. The compression spring 35 is supported on the side facing away from the desiccant 14 at the outer housing 39 of the air dryer cartridge 5.

Many variations and modifications may be made to the preferred embodiments of the invention without departing substantially from the spirit and principles of the invention. All such modifications and variations are intended to be included herein within the scope of the present invention, as defined by the following claims.

I claim:

1. An exchangeable air dryer cartridge for a compressed air system of a commercial vehicle with
a) a release valve by which a controlled release of humidity, fluids or contaminants is provided
b) a base element coupling region,
ba) by which it is possible to couple the air dryer cartridge to a base element of an air dryer,
bb) which comprises a control port for a control signal for controlling the release valve,
c) a release valve coupling region to which the release valve can be coupled or is coupled,
d) the base element coupling region and the release valve coupling region being arranged on opposite sides of the air dryer cartridge and
e) a control line or control conduit by which the control signal for controlling the release valve is transmitted extending from the base element coupling region through an interior of the air dryer cartridge to the release valve coupling region.

2. The air dryer cartridge of claim 1, wherein the control line or control conduit extends through a desiccant of the air dryer cartridge.

3. The air dryer cartridge of claim 1, wherein a transmitting body is provided which forms the control line or control conduit and which extends through the interior of the air dryer cartridge.

4. The air dryer cartridge of claim 3, wherein the transmitting body is formed integrally with an accommodating body for the desiccant.

5. The air dryer cartridge of claim 3, wherein the transmitting body is formed integrally with a connecting region for electrically connecting or pneumatically connecting in a sealed fashion the control line or control conduit of the transmitting body to a connecting region of the base element.

6. The air dryer cartridge of claim 3, wherein the transmitting body is formed integrally with a connecting region for electrically connecting or pneumatically connecting in a sealed fashion the control line or control conduit of the transmitting body to the release valve.

7. The air dryer cartridge of claim 3, wherein the transmitting body extends in the region or coaxially to a longitudinal or rotational axis of the air dryer cartridge.

8. The air dryer cartridge of claim 1, wherein the control conduit is a pneumatical control conduit for a pneumatic control pressure.

9. The air dryer cartridge of claim 1, wherein the control line is an electric control line for an electric control signal.

10. The air dryer cartridge of claim 1, wherein a heating line or heating conduit by which a heating signal for controlling a heating element which is arranged in the region of the release valve is transmitted extends from the base element coupling region through the interior of the air dryer cartridge to the release valve coupling region.

11. The air dryer cartridge of claim 1, wherein the air dryer cartridge is a spin-on-cartridge.

12. The air dryer cartridge of claim 1, wherein the air dryer cartridge is an insertion cartridge which can be arranged in an inner space limited by a base element and a housing lid of an air dryer.

13. An air dryer comprising a base element and an air dryer cartridge according to claim 1, the air dryer cartridge being held at the base element.

14. The air dryer of claim 13, wherein the air dryer cartridge is assembled from below or from the side to the base element.

15. The air dryer of claim 13, wherein an electric or pneumatic sealed connection between the base element and the base element coupling region of the air dryer cartridge is automatically established when assembling the air dryer cartridge to the base element.

16. The air dryer of claim 13, wherein a housing lid is provided which is connected by a bayonet connection to the base element.

17. The air dryer of claim 13, wherein at least one member of the group built by
a) a solenoid valve for generating a control pressure for the release valve,
b) a solenoid valve for controlling a regeneration and
c) a non-return valve for securing a pressure downstream of the outlet of the air dryer cartridge
is integrated into the base element or attached to the base element.

18. The air dryer according to claim 13, wherein the release valve, a valve seat, a valve body, a valve piston, a valve spring or a heating element is releasably connected to a housing lid or the air dryer cartridge.

19. The air dryer of claim 13, wherein a helical conduit is formed between a wall of the air dryer cartridge and a housing lid.
